(19) United States
(12) Patent Application Publication
(10) Pub. No.: US 2025/0392890 A1
(43) Pub. Date: Dec. 25, 2025

(54) VEHICLE NETWORK SYSTEM AND VEHICLE SERVICE COMMUNICATION METHOD BASED ON UWB FOR V2X COMMUNICATION

(71) Applicant: HL Klemove Corp., Incheon (KR)

(72) Inventors: Ah Ra LEE, Incheon (KR); Min-Gyu KIM, Incheon (KR); Jae-Bum PARK, Incheon (KR)

(73) Assignee: HL Klemove Corp., Incheon (KR)

(21) Appl. No.: 18/973,415

(22) Filed: Dec. 9, 2024

(30) Foreign Application Priority Data
Jun. 20, 2024 (KR) 10-2024-0080108

(51) Int. Cl. H04W 4/40; H04B 1/7163; H04W 48/16

(52) U.S. Cl. CPC H04W 4/40; H04W 48/16; H04B 1/7163

(57) ABSTRACT

The present disclosure is a vehicle network system based on an ultra-wideband (UWB) for a vehicle to everything (V2X) communication, including a communication controller configured to communicate with a plurality of external devices based on an ultra-wideband and receive a service from the plurality of external devices, a plurality of individual controllers configured to search for and subscribe to the service, and a domain controller configured to receive the service from the communication controller and transmit it to each of the individual controllers.

### CROSS-REFERENCE TO RELATED APPLICATION

This application claims priority to and the benefit from Korean Patent Application No. 10-2024-0080108, filed on Jun. 20, 2024, the disclosures of which are incorporated herein by reference in its entirety.

### BACKGROUND

The present disclosure relates to a vehicle network system and a vehicle service communication method based on an UWB for a V2X communication.

Software-defined vehicle (SDV) is giving rise to a large paradigm change in the existing internal combustion engine automotive industry, which has been firmly established since the 19th century.

Unlike automobiles that have been operated based on physical electrical hardware, the software-defined vehicle is a vehicle in which the core functions of the vehicle are determined by software, just like smartphones. The key to innovation is that continuous upgrade and performance improvement is possible in a manner similar to smartphone update, and diverse and novel application services can emerge.

The connectivity of the software-defined vehicle is expanding automobiles into the concept of smart mobility, not simple means of transportation. Advanced technologies such as autonomous driving can not only change the automobile hardware itself but also completely change the driver's lifestyle, such as changing the interior space of the vehicle for driving into a variety of living spaces.

As the transition to the software-defined vehicle becomes earnest, various possibilities for software are opening up, and the Electric/Electronic (E/E) architecture is evolving into a service-oriented architecture.

On the other hand, vehicle to everything (V2X) communication technology is essential in autonomous vehicles. Here, the V2X is a technology in which the vehicle communicates with various elements of the surrounding environment, such as pedestrian devices, road traffic system equipped devices, and other vehicles through a communication network. To realize this V2X technology, a unified communication protocol is required.

Here, controller area network (CAN) communication is widely used in the field of vehicle communication, and is still widely used today. However, as the amount of communication of the vehicle increases, restrictions on the amount and speed of data transmission of the CAN communication are emerging. There is a protocol that increases the amount of data such as CAN-flexible data rate (FD), but it is rapidly replaced by vehicle Ethernet communication.

### SUMMARY

The purpose of the present disclosure is to enable a vehicle to easily search for and subscribe to services provided by external devices, and to transmit various services by performing V2X communication with the external devices.

In addition, the present disclosure aims to form a network without considering the network inside the vehicle if forming an external communication network with the external devices.

The technical problems of the present disclosure are not limited to the above-mentioned technical problems, and other technical problems not mentioned may be clearly understood by those skilled in the art to which the present disclosure pertains from the following description.

The present disclosure provides a vehicle network system based on an ultra-wideband (UWB) for a vehicle to everything (V2X) communication, including a communication controller configured to communicate with a plurality of external devices based on an ultra-wideband and receive a service from the plurality of external devices; a plurality of individual controllers configured to search for and subscribe to the service; and a domain controller configured to receive the service from the communication controller and transmit it to each of the individual controllers.

According to an exemplary embodiment of the present disclosure, the communication controller may be assigned a dynamic IP address, and the plurality of individual controllers and the domain controller may be assigned unique IP addresses.

According to an exemplary embodiment of the present disclosure, the communication controller may receive an offer service message from the plurality of external devices and transmit it to the domain controller.

According to an exemplary embodiment of the present disclosure, each of the plurality of individual controllers may transmit a find service message to the domain controller.

According to an exemplary embodiment of the present disclosure, the domain controller may determine whether to subscribe to the service based on the offer service message and the find service message.

According to an exemplary embodiment of the present disclosure, the domain controller may transmit a subscription message to the communication controller based on determining to subscribe to the service.

According to an exemplary embodiment of the present disclosure, the communication controller may receive a subscription acknowledgement message from each of the plurality of external devices and transmit the subscription acknowledgement message to the domain controller based on the subscription message received by each of the plurality of external devices.

According to an exemplary embodiment of the present disclosure, the domain controller may store information on each of the individual controllers that subscribes to the service based on the subscription message.

According to an exemplary embodiment of the present disclosure, the communication controller may receive event information from the plurality of external devices.

According to an exemplary embodiment of the present disclosure, the domain controller may receive the event information from the communication controller and transmit it to each of the individual controllers that subscribes to the service.

According to an exemplary embodiment of the present disclosure, the domain controller may transmit the event information to each of the individual controllers that subscribes to the service based on the information on each of the individual controllers.

According to an exemplary embodiment of the present disclosure, the domain controller may receive request information from each of the plurality of individual controllers and transmit it to the communication controller.

According to an exemplary embodiment of the present disclosure, the communication controller may transmit the request information to each of the external devices based on the information on each of the external devices.

According to an exemplary embodiment of the present disclosure, the communication controller may receive response information corresponding to the request information from each of the external devices.

According to an exemplary embodiment of the present disclosure, the domain controller may receive the response information from the communication controller and transmit it to each of the individual controllers.

According to an exemplary embodiment of the present disclosure, the domain controller may transmit the response information to each of the individual controllers based on the information on each of the individual controllers.

The present disclosure provides a vehicle service communication method based on an ultra-wideband (UWB) for a vehicle to everything (V2X) communication, including: searching for and subscribing to a service transmitted by a plurality of external devices; receiving, with a communication controller, a service from a plurality of external devices in communication with the plurality of external devices based on ultra-wideband; and receiving, with a domain controller, the service from the communication controller, and transmitting the service to at least one of a plurality of individual controllers.

According to an exemplary embodiment of the present disclosure, the searching for and subscribing to the service may include receiving, with the communication controller, an offer service message from each of the plurality of external devices; receiving, with the domain controller, the offer service message from the communication controller; transmitting, with each of the plurality of individual controllers, a find service message to the domain controller; and determining, with the domain controller, whether to subscribe to the service based on the offer service message and the find service message.

According to an exemplary embodiment of the present disclosure, the transmitting the service to at least one of a plurality of individual controllers may include receiving, with the communication controller, event information from each of the plurality of external devices; and receiving, with the domain controller, the event information from the communication controller and transmitting the service to at least one of the plurality of individual controllers.

According to an exemplary embodiment of the present disclosure, the transmitting the service to at least one of a plurality of individual controllers may include receiving, with the domain controller, request information from the plurality of individual controllers and transmitting it to the communication controller; transmitting, with the communication controller, the request information to each of the external devices based on the information on each of the external devices; receiving, with the communication controller, response information corresponding to the request information from each of the external devices; and receiving, with the domain controller, the response information from the communication controller and transmitting it to at least one of the plurality of individual controllers.

According to the present disclosure, the vehicle can easily search for and subscribe to services provided by the external devices using SOME/IP-SD, and can receive various services by performing V2X communication with the external devices using SOME/IP.

In addition, according to the present disclosure, by separating a part communicating with the outside of the vehicle and a part communicating with the inside the vehicle, the network inside the vehicle is not necessary to consider in forming a network with external communication with the external device.

The effects of the present disclosure are not limited to the above effects, and it should be understood that they include all effects that can be inferred from the detailed description of the present disclosure or the composition of the disclosure described in the claims.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of a vehicle network system based on an ultra-wideband (UWB) for a vehicle to everything (V2X) communication according to an embodiment of the present disclosure.

FIG. 2 is a diagram for explaining a method for searching for, subscribing to, and providing a service using SOME/IP-SD and SOME/IP.

FIG. 3 is a flowchart of a vehicle service communication method based on an UWB for a V2X communication according to an embodiment of the present disclosure.

FIG. 4 is a detailed flowchart of a step of searching for and subscribing to a service of the present disclosure,

FIG. 5 is a detailed flowchart of a step of transmitting an event to an individual controller among the service of the present disclosure.

FIG. 6 is a detailed flowchart of a step of transmitting a method to an individual controller among the service of the present disclosure

### DETAILED DESCRIPTION

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

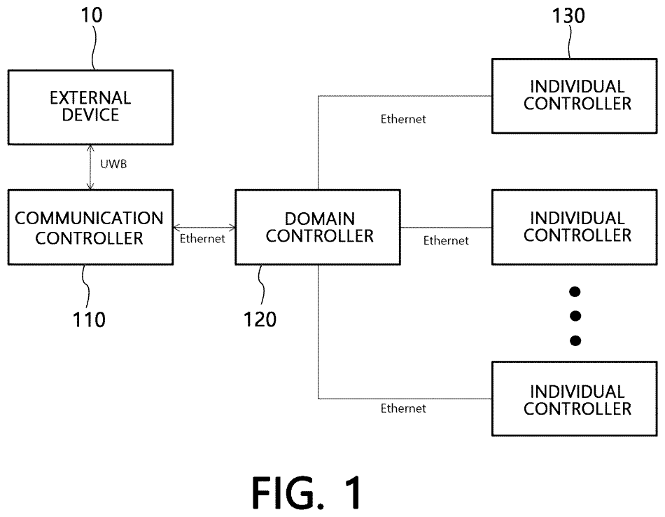

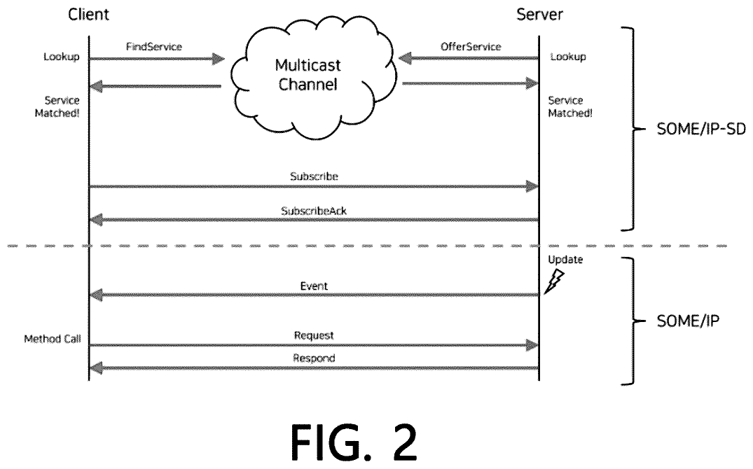

FIG. 1 is a block diagram of a vehicle network system based on an ultra-wideband (UWB) for a vehicle to everything (V2X) communication according to an embodiment of the present disclosure, and FIG. 2 is a diagram for explaining a method for searching for, subscribing to, and providing a service using SOME/IP-SD and SOME/IP.

As shown in FIG. 1, the vehicle network system based on the UWB for the V2X communication according to an embodiment of the present disclosure may include a communication controller 110, a domain controller 120, and a plurality of individual controllers 130.

Here, the V2X communication refers to a technology in which a vehicle communicates with various elements on the road for autonomous driving. It consists of vehicle to vehicle (V2V) communication that notifies a front traffic situation and an approach between vehicles, vehicle to infrastructure (V2I) communication that communicates with traffic infrastructure such as traffic lights, and vehicle to pedestrian (V2P) communication that support pedestrian information. In addition, the UWB technology is a short range wireless communication protocol that operates via radio waves in a high frequency band.

The communication controller 110 performs V2X communication with a plurality of external devices 10 based on UWB, and may receive a service from the plurality of external devices 10.

Here, the plurality of external devices 10 may be communication terminals equipped on other vehicles, traffic lights, pedestrians, and the like.

In addition, the service provided by the plurality of external devices 10 may be a service in which other vehicles in driving or stopping transmit signals or data. In this service, a speed, location, and direction of other vehicles in front of the own vehicle are received to detect the possibility of collision and automatically warn or brake to prevent accidents.

In addition, the service provided by the plurality of external devices 10 may be a service in which traffic lights installed at an intersection transmits signals or data. This service provides optimal signal timing through real-time communication with the traffic lights and analyzes the speed and flow of vehicles to reduce traffic congestion and manage the traffic signals efficiently.

In addition, the service provided by the plurality of external devices 10 may be a service in which emergency vehicles such as rescue vehicles and fire trucks transmit signals or data. In this service, the emergency vehicles transmit data for priority driving to surrounding vehicles and infrastructure, thereby allowing the emergency vehicles to arrive at the destination quickly and smoothing traffic flow.

The communication controller 110 may be equipped in the vehicle and dynamic IP address may be allocated through Dynamic Host Configuration Protocol (DHCP). Accordingly, communication between the vehicles in driving and the external devices 10 may be performed.

Here, the DHCP is a standard network protocol used to dynamically set network configuration parameters for performing TCP/IP communication, such as an IP address.

A network administrator should allocate and manage the IP address to hosts within the IP address block allocated from the Internet Service Provider (ISP). To do this, it is necessary to allocate the IP address for each host and to set new IP addresses for each host move. At this time, using the DHCP, the network administrator may automatically manage these tasks without manually performing them, and the DHCP allows the hosts to be dynamically allocated the IP addresses whenever the hosts want to connect to the network.

The domain controller 120 may receive a service received from the plurality of external devices 10 by the communication controller 110 and transmit the received service to the plurality of individual controllers 130.

The communication controller 110 and the domain controller 120 may perform communication based on Ethernet and transmit and receive data.

The domain controller 120 is a device that partially integrates the roles of a plurality of individual controllers 110 that control various products constituting the Advanced Driver Assistance System (ADAS) to recognize and command various and complex signals to control the system.

In addition, the domain controller 120 may route data between the plurality of individual controllers 130 in the corresponding domain.

The plurality of individual controllers 130 may search for and subscribe to services provided by the plurality of external devices 10. This will be described in detail below.

The plurality of individual controllers 130 may be electronic control devices that control the status of ADAS, infotainment, engine, steering wheel, and brake and the like by computer.

The domain controller 120 and a plurality of individual controllers 130 may be allocated a unique IP address and transmit and receive data based on Ethernet.

Here, the Ethernet is a networking protocol widely used to connect devices to establish a local area network (LAN), and support the devices to communicate by exchanging data packets with other devices through the network.

Specifically, if one device on the network transmits data to another device, the Ethernet generates data packets including a source and a target Media Access Control (MAC) address as well as content. Here, the packet is subsequently transmitted to a target device via Ethernet cable, and if the target device is not connected to the same network, the packet is routed through the router until it arrives at the destination. In addition, if the device receives the data packet, it checks whether the target MAC address matches with its own MAC address, and if the target MAC address matches its own MAC address, the data packet is allowed and data is taken, and if the target MAC address does not match its own MAC address, the data packet is rejected.

The plurality of individual controllers 130 may receive the service from the plurality of external devices 10 using Scalable service-Oriented Middleware over IP (SOME/IP).

Here, the communication controller 110 transmits a service requested by the plurality of individual controllers 130 to the plurality of external devices 10 based on UWB, and receives the service from the plurality of external devices 10. Thereafter, the communication controller 110 transmits the received service to the plurality of individual controllers 130.

The SOME/IP is a middleware for the vehicle environment designed to transmit and receive control commands via the Ethernet. Recently, as driving assistance technology and autonomous driving technology have been developed, communication methods such as Controller Area Network (CAN) and CAN Flexible Data Rate (CAN-PD), which have been mainly used for network communication between existing vehicle controllers, have become increasingly difficult to cope with increasing traffic. Accordingly, a protocol called SOME/IP, which uses Ethernet and IP suitable for high-speed transmission and reception of large amounts of data, has been proposed.

The SOME/IP uses a service-oriented communication method, which is compared to the existing signal-oriented communication method, and if the existing method focuses on the contents of messages delivered through communication media such as CAN, Local Interconnect Network (LIN), and FlexRay, the service-oriented communication method divides each instance of the network into a server that provides a service and a client that receives a service, and communication is configured based on the services used by them.

The middleware refers to software and services that connect two systems to enable data communication and management. The SOME/IP aims to implement connections between each instance within a vehicle controller or between different controllers at a high level of compatibility.

The SOME/IP corresponds to five to seven layers of the OSI seven layer, and is configured on top of the Ethernet, the IP, and the TCT/UDP protocols. Therefore, if compared to the CAN and CAN-FD, which was mainly used as the existing vehicle controller network, the SOME/IP may secure the ability to transmit large amounts of data generated by the introduction of the autonomous driving system at a faster speed.

The SOME/IP may use the SOME/IP-service discovery (SD) to apply the service-oriented communication method.

Here, the SOME/IP-SD searches for a place where the external device 10 needs the service, and searches for the external device providing the service required by the client. Accordingly, each instance of the network may dynamically search for and connect to an instance that needs its own service or that has the service it needs.

The SOME/IP-SD is defined in a higher layer than the SOME/IP protocol. That is, the contents of the SOME/IP-SD message are carried in the payload of the SOME/IP message, and the SOME/IP-SD delivers the message to all nodes in the same multicast group using User Datagram Protocol (UDP) multicast.

Referring to FIG. 2, using the SOME/IP-SD protocol, a server transmits an offer service message to provide its own service to a multicast channel, and a plurality of clients transmit find service messages to receive a service of their own needs to a multicast channel using the SOME/IP-SD protocol.

Here, the offer service message includes ID of the service provided by the server and IP address of the server, and the find service message includes ID of the service needed by the client and IP address of each of the clients.

If the offer service message and the find service message are matched, each of the clients stores necessary information, such as the ID of the service included in the offer service message and the IP address of the server, and the server stores necessary information, such as the ID of the service included in the find service message and the IP address of each of the clients.

The client may determine the subscription of the service provided by the server after the offer service message and the find service message are matched. In this case, the client transmits a subscription message to the server, and the server transmits a subscription acknowledgement message to the client based on receiving the subscription message.

Using the SOME/IP, the service the client receives from the server may include an event, a method, and a field.

Here, the event is a one-way data transmission performed periodically or when there is an update in the data. In other words, the event refers to a passive data transmission from the server to the client.

In addition, the method means that if the client intends to use the method that the server has, the client transmits the request message to the server, executes the method by the request message received by the server, and transmits the result to the client in a response message.

On the other hand, some clients do not wait for the response of the server after transmitting the request message to the server, which is called ‘Fire and Forget’.

In addition, the fields include getter, setter, and notifier, which are a kind of method for handling the value of the field on the server.

Here, the getter is used when the client intends to obtain the value of the current field, and the server transmits a response message containing the value of the field to the client if the request message is received from the client.

In addition, the setter is used when the client intends to change the value of the current field, and if the value of the field to be changed by the client is contained in the request message and transmitted to the server, the server changes the value of the field based on to the request of the client, and then transmits the changed value in the response message to the client.

In addition, the notifier periodically transmits the value of the current field to the client according to the changed value of the field or a preset period.

Using the SOME/IP-SD protocol, the plurality of external devices 10 transmit offer service messages to provide their own service, and the plurality of individual controllers 130 transmit find service messages to receive a service of their own needs using the SOME/IP-SD protocol.

The plurality of individual controllers 130 transmit a first find service message to the domain controller 120, and the plurality of external devices 10 transmit a first offer service message to the communication controller 110.

Here, the first offer service message includes the ID of the service provided by the external device 10 and the dynamic IP address of the external device 10, and the first find service message includes the ID of the service required by the individual controller 130 and the unique IP address of the individual controller 130.

The domain controller 120 generates a second find service message including the unique IP address of the domain controller 120 instead of the unique IP address of each of the plurality of individual controllers 130 from the first find service message received from each of the plurality of individual controllers 130, and transmits the second find service message to the communication controller 110.

The communication controller 110 generates a third find service message by including the dynamic IP address of the communication controller 110 instead of the unique IP address of the domain controller 120 in the second find service message received from the domain controller 120, and transmits the third find service message to the plurality of external devices 10.

The plurality of external devices (10) map the dynamic IP address of the communication controller (110) included in the third find service message to the ID of the service provided by the external devices 10 and store it, if the ID of the service included in the third find service message received from the communication controller 110 matches the ID of the service provided by the external devices 10.

The communication controller 110 generates a second offer service message by including a unique IP address of the communication controller 110 in the first offer service message received from the plurality of external devices 10 instead of the dynamic IP address of the plurality of external devices 10, and transmits the second offer service message to the domain controller 120.

Here, the communication controller 110 maps and stores the ID of the service provided by each of the external device 10 and the dynamic IP address of each of the external device.

If the ID of the service included in the second offer service message received from the communication controller 110 matches the ID of the service included in the first find service message received from the individual controller 130, the domain controller 120 maps and stores the service ID and a unique IP address of the individual controller 130.

The domain controller 120 may determine whether to subscribe to the service based on the matching of the ID of the service included in the second offer service message and the ID of the service included in the first find service message.

The domain controller 120 may transmit a first subscription message to the communication controller 110 based on the determination of the service subscription. Here, the first subscription message includes an ID of the subscription-determined service and a unique IP address of the domain controller 120.

The communication controller 110 searches for the dynamic IP address of the external device 10 mapped to the ID of the service included in the first subscription message. Then, the communication controller 110 generates a second subscription message including the dynamic IP address of the communication controller 110 instead of the unique IP address of the domain controller 120 in the first subscription message, and transmits the second subscription message to the external device 10 having the searched dynamic IP address.

The external device 10 transmits a first subscription acknowledgement message to the communication controller 110 based on receiving the second subscription message. Here, the first subscription acknowledgement message includes the dynamic IP address of the external device.

Here, the external device 10 maps and stores the dynamic IP address included in the second subscription message with the ID of the subscribed service.

The communication controller 110 generates a second subscription acknowledgement message including the dynamic IP address of the communication controller 110 instead of the dynamic IP address of the external device 10 in the first subscription acknowledgement message, and transmits the second subscription acknowledgement message to the domain controller 10.

The services that the plurality of individual controllers 130 receive from the plurality of external devices 10 may include the event and the method.

Specifically, if an event occurs in the subscribed service, the external device 10 searches for the dynamic IP address of the communication controller 110 mapped to the ID of the subscribed service, and transmits a first event message to the communication controller 110 having the searched dynamic IP address. Here, the first event message includes the ID of the service and the dynamic IP address of the external device 10.

The communication controller 110 generates a second event message by including the unique IP address of the communication controller 110 instead of the dynamic IP address of the external device 10 in the first event message received from the external device 10, and transmits the second event message to the domain controller 120.

The domain controller 120 searches for a unique IP address of the individual controller 130 mapped to the ID of the service included in the second event message. Then, the domain controller 120 generates a third event message including the unique IP address of the domain controller 120 instead of the unique IP address of the communication controller 110 in the second event message, and transmits the third event message to the individual controller 130 having the searched unique IP address.

The individual controller 130 transmits a first request message for using the method to the domain controller 120. Here, the first request message includes an ID of the subscribed service and a unique IP address of the individual controller 130.

The domain controller 120 generates a second request message by including the unique IP address of the domain controller 120 instead of the unique IP address of the individual controller 130 in the first request message received from the individual controller 130, and transmits the second request message to the communication controller 110.

The communication controller 110 searches for the dynamic IP address of the external device 10 mapped to the ID of the service included in the second request message, generates a third request message by including the dynamic IP address of the communication controller 110 instead of the unique IP address of the domain controller 120 in the second request message, and transmits the third request message to the external device 10 having the searched dynamic IP address.

The external device 10 executes the method based on the third request message and generates a first response message including the result value.

The external device 10 searches for the dynamic IP address of the communication controller 110 mapped to the ID of the service included in the third request message, and transmits the first response message to the communication controller 110 having the searched dynamic IP address. Here, the first response message includes a result value of executing the method, an ID of the service, and a dynamic IP address of the external device 10.

The communication controller 110 generates a second response message by including the unique IP address of the communication controller 110 instead of the dynamic IP address of the external device 10 in the first response message received from the external device 10, and transmits the second response message to the domain controller 120.

The domain controller 120 searches for a unique IP address of the individual controller 130 mapped to the ID of the service included in the second response message. Then, the domain controller 120 generates a third response message including the unique IP address of the domain controller 120 instead of the unique IP address of the communication controller 110 in the second response message, and transmits the third response message to the individual controller 130 having the searched unique IP address.

Meanwhile, although the vehicle has been described as the method for providing the service from the external device 10 by performing V2X communication with the external device 10 using the SOME/IP, it is not limited thereto, and the service may be transmitted and received by performing Ethernet communication between the plurality of individual controllers 130 using the SOME/IP.

According to the present disclosure, the vehicle may easily search for and subscribe to services provided by external devices using the SOME/IP-SD, and may receive various services by performing V2X communication with the external devices using the SOME/IP.

In addition, according to the present disclosure, by separating a part communicating with the outside of the vehicle and a part communicating with the inside the vehicle, the network inside the vehicle is not necessary to consider in forming a network with external communication with the external device.

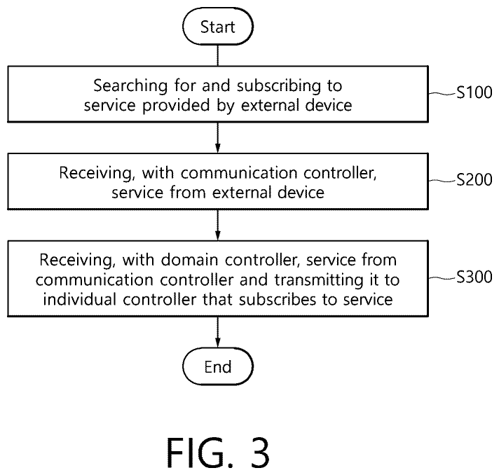

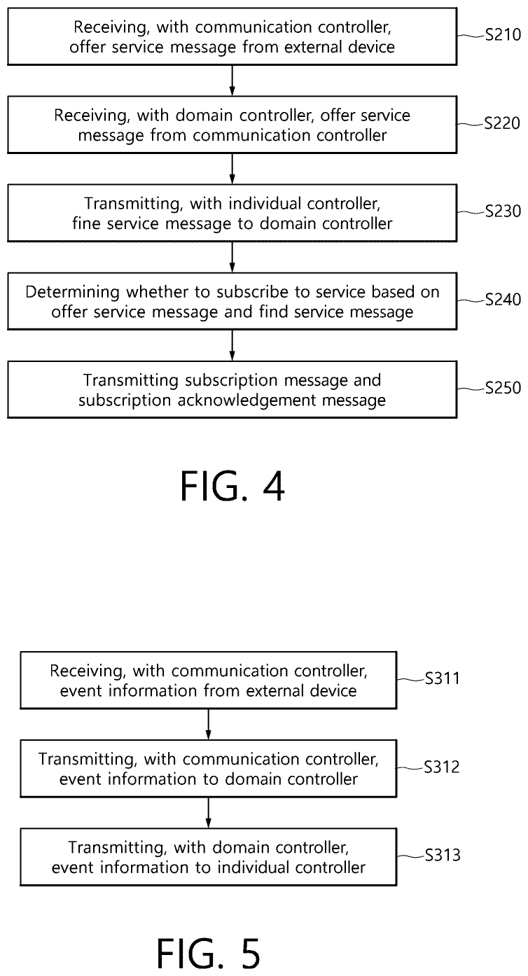

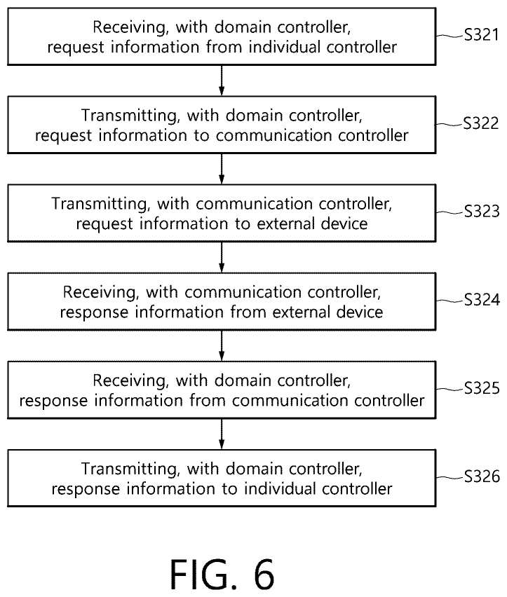

FIG. 3 is a flowchart of a vehicle service communication method based on an UWB for a V2X communication according to an embodiment of the present disclosure, FIG. 4 is a detailed flowchart of a step of searching for and subscribing to a service of the present disclosure, FIG. 5 is a detailed flowchart of a step of transmitting an event to an individual controller among the service of the present disclosure, and FIG. 6 is a detailed flowchart of a step of transmitting a method to an individual controller among the service of the present disclosure.

Hereinafter, a vehicle service communication method based on an UWB for a V2X communication according to an embodiment of the present disclosure will be described with reference to FIGS. 3 to 6, but the same contents as those described above will be omitted.

As shown in FIG. 3, the UWB-based vehicle service communication method for the V2X communication according to an embodiment of the present disclosure includes first searching for and subscribing to service provided by a plurality of external devices 10 (step S100).

Next, the communication controller 110 receives the service from an external device (step S200).

Next, the domain controller 120 receives the service from the communication controller 110 and transmits the service to the individual controller 130 that subscribes to the service (step S300).

As shown in FIG. 4, in the step of searching for and subscribing to the service provided by the plurality of external devices 10 (step S100), first, using a SOME/IP-SD protocol, the plurality of external devices 10 transmit a first offer service message for providing the service that the external devices 10 have, and the communication controller 110 receives the first offer service message from the external devices 10 (step S210).

Here, the first offer service message includes an ID of the service provided by each of the external devices 10 and a dynamic IP address of each of the external devices 10.

Next, the communication controller 110 generates a second offer service message by including a unique IP address of the communication controller 110 in the first offer service message received from the plurality of external devices 10 instead of the dynamic IP address of the plurality of external devices 10, and the domain controller 120 receives the second offer service message from the communication controller 110 (step S220).

Here, the communication controller 110 maps and stores the ID of the service provided by the external devices 10 and the dynamic IP address of the external devices 10.

Next, the plurality of individual controllers 130 transmit a first fine service message to the domain controller 120 (step S230).

Here, the first fine service message includes an ID of the service required by the individual controller 130 and a unique IP address of the individual controller 130.

Next, if the ID of the service included in the second offer service message received from the communication controller 110 matches the ID of the service included in the first find service message received from the individual controller 130, the domain controller 120 maps and stores the service ID and a unique IP address of the individual controller 130.

Next, The domain controller 120 determines whether to subscribe to the service based on the matching of the ID of the service included in the second offer service message and the ID of the service included in the first find service message (step S240).

Next, a subscription message and a subscription acknowledgement message are transmitted (step S250).

Specifically, first, the domain controller 120 transmits a first subscription message to the communication controller 110 based on the determination of the service subscription. Here, the first subscription message includes an ID of the subscription-determined service and a unique IP address of the domain controller 120.

Next, the communication controller 110 searches for the dynamic IP address of the external device 10 mapped to the ID of the service included in the first subscription message. Then, the communication controller 110 generates a second subscription message including the dynamic IP address of the communication controller 110 instead of the unique IP address of the domain controller 120 in the first subscription message, and transmits the second subscription message to the external device 10 having the searched dynamic IP address.

Next, the external device 10 transmits a first subscription acknowledgement message to the communication controller 110 based on receiving the second subscription message. Here, the first subscription acknowledgement message includes the dynamic IP address of the external device.

Next, the external device 10 maps and stores the dynamic IP address included in the second subscription message with the ID of the subscribed service.

Next, the communication controller 110 generates a second subscription acknowledgement message including the dynamic IP address of the communication controller 110 instead of the dynamic IP address of the external device 10 in the first subscription acknowledgement message, and transmits the second subscription acknowledgement message to the domain controller 10.

As shown in FIG. 5, the step of transmitting the service to the individual controller 130 that subscribes to the service (step S300) is specifically performed, first, if an event occurs in the subscribed service, the external device 10 searches for the dynamic IP address of the communication controller 110 mapped to the ID of the subscribed service, and transmits a first event message to the communication controller 110 having the searched dynamic IP address (step S311). Here, the first event message includes an ID of the service and a dynamic IP address of the external device 10.

Next, the communication controller 110 generates a second event message by including the unique IP address of the communication controller 110 instead of the dynamic IP address of the external device 10 in the first event message received from the external device 10, and transmits the second event message to the domain controller 120 (step S312).

Next, the domain controller 120 searches for a unique IP address of the individual controller 130 mapped to the ID of the service included in the second event message.

Then, the domain controller 120 generates a third event message including the unique IP address of the domain controller 120 instead of the unique IP address of the communication controller 110 in the second event message, and transmits the third event message to the individual controller 130 having the searched unique IP address (step S313).

As shown in FIG. 6, the step of transmitting the service to the individual controller 130 that subscribes to the service (step S300) includes specifically receiving a first request message for using a method from the individual controller 130 (step S321). Here, the first request message includes an ID of the subscribed service and a unique IP address of the individual controller 130.

Next, the domain controller 120 generates a second request message by including the unique IP address of the domain controller 120 instead of the unique IP address of the individual controller 130 in the first request message received from the individual controller 130, and transmits the second request message to the communication controller 110 (step S322).

Next, the communication controller 110 searches for the dynamic IP address of the external device 10 mapped to the ID of the service included in the second request message, generates a third request message by including the dynamic IP address of the communication controller 110 instead of the unique IP address of the domain controller 120 in the second request message, and transmits the third request message to the external device 10 having the searched dynamic IP address (step S323).

Next, the external device 10 executes the method based on the third request message and generates a first response message including the result value.

Next, the external device 10 searches for the dynamic IP address of the communication controller 110 mapped to the ID of the service included in the third request message.

Next, the communication controller 110 having the searched dynamic IP address receives a first response message from the external device 10 (step S324). Here, the first response message includes a result value of executing the method, an ID of the service, and a dynamic IP address of the external device 10.

Next, the communication controller 110 generates a second response message by including the unique IP address of the communication controller 110 instead of the dynamic IP address of the external device 10 in the first response message received from the external device 10.

Next, the domain controller 120 receives a second response message from the communication controller 110 (step S325).

Next, the domain controller 120 searches for a unique IP address of the individual controller 130 mapped to the ID of the service included in the second response message.

Next, the domain controller 120 generates a third response message including the unique IP address of the domain controller 120 instead of the unique IP address of the communication controller 110 in the second response message, and transmits the third response message to the individual controller 130 having the searched unique IP address (step S326).

According to the above-described present disclosure, the vehicle may easily search for and subscribe to services provided by external devices using the SOME/IP-SD, and may receive various services by performing V2X communication with the external devices using the SOME/IP.

In addition, according to the present disclosure, by separating a part communicating with the outside of the vehicle and a part communicating with the inside the vehicle, the network inside the vehicle is not necessary to consider in forming a network with external communication with the external device.

It should be understood that the effects of the present disclosure are not limited to the above-described effects, and include all effects inferable from a configuration of the disclosure described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A vehicle network system based on an ultra-wideband (UWB) for a vehicle to everything (V2X) communication, the system comprising:
a communication controller configured to communicate with a plurality of external devices based on an ultra-wideband and receive a service from the plurality of external devices;
a plurality of individual controllers configured to search for and subscribe to the service; and
a domain controller configured to receive the service from the communication controller and transmit it to each of the individual controllers.

2. The system of claim 1, wherein the communication controller is configured to be assigned a dynamic IP address, and the plurality of individual controllers and the domain controller are configured to be assigned unique IP addresses.

3. The system of claim 1, wherein the communication controller is configured to receive an offer service message from the plurality of external devices and transmit it to the domain controller.

4. The system of claim 3, wherein each of the plurality of individual controllers is configured to transmit a find service message to the domain controller.

5. The system of claim 4, wherein the domain controller is configured to determine whether to subscribe to the service based on the offer service message and the find service message.

6. The system of claim 5, wherein the domain controller is configured to transmit a subscription message to the communication controller, if determining to subscribe to the service.

7. The system of claim 6, wherein the communication controller is configured to receive a subscription acknowledgement message from each of the plurality of external devices and transmit the subscription acknowledgement message to the domain controller, if each of the plurality of external devices receives the subscription message.

8. The system of claim 7, wherein the domain controller is configured to store information on each of the individual controllers that subscribes to the service based on the subscription message.

9. The system of claim 1, wherein the communication controller is configured to receive event information from the plurality of external devices.

10. The system of claim 9, wherein the domain controller is configured to receive the event information from the communication controller and transmit it to each of the individual controllers that subscribes to the service.

11. The system of claim 10, wherein the domain controller is configured to transmit the event information to each of the individual controllers that subscribes to the service based on the information on each of the individual controllers.

12. The system of claim 1, wherein the domain controller is configured to receive request information from each of the plurality of individual controllers and transmit it to the communication controller.

13. The system of claim 12, wherein the communication controller is configured to transmit the request information to each of the external devices based on the information on each of the external devices.

14. The system of claim 13, wherein the communication controller is configured to receive response information corresponding to the request information from each of the external devices.

15. The system of claim 13, wherein the domain controller is configured to receive the response information from the communication controller and transmit it to each of the individual controllers.

16. The system of claim 13, wherein the domain controller is configured to transmit the response information to each of the individual controllers based on the information on each of the individual controllers.

17. A vehicle service communication method based on an ultra-wideband (UWB) for a vehicle to everything (V2X) communication, the method comprising:
searching for and subscribing to a service transmitted by a plurality of external devices;
receiving, with a communication controller, a service from a plurality of external devices in communication with the plurality of external devices based on ultra-wideband; and
receiving, with a domain controller, the service from the communication controller, and transmitting the service to at least one of a plurality of individual controllers.

18. The method of claim 17, wherein the searching for and subscribing to the service includes:
receiving, with the communication controller, an offer service message from each of the plurality of external devices;
receiving, with the domain controller, the offer service message from the communication controller;
transmitting, with each of the plurality of individual controllers, a find service message to the domain controller; and
determining, with the domain controller, whether to subscribe to the service based on the offer service message and the find service message.

19. The method of claim 17, wherein the transmitting the service to at least one of a plurality of individual controllers includes:
receiving, with the communication controller, event information from each of the plurality of external devices; and
receiving, with the domain controller, the event information from the communication controller and transmitting the service to at least one of the plurality of individual controllers.

20. The method of claim 17, wherein the transmitting the service to at least one of a plurality of individual controllers includes:
receiving, with the domain controller, request information from the plurality of individual controllers and transmitting it to the communication controller;
transmitting, with the communication controller, the request information to each of the external devices based on the information on each of the external devices;
receiving, with the communication controller, response information corresponding to the request information from each of the external devices; and
receiving, with the domain controller, the response information from the communication controller and transmitting it to at least one of the plurality of individual controllers.
